(19) United States
(12) Patent Application Publication
(10) Pub. No.: US 2015/0122139 A1
(43) Pub. Date: May 7, 2015

(54) SYSTEM AND METHOD FOR TRANSFERRING IMAGES ONTO SUBSTRATES

(71) Applicant: Bülent ÖZ, Mannheim (DE)

(72) Inventor: Bülent Öz, Mannheim (DE)

(21) Appl. No.: 14/397,235

(22) PCT Filed: Apr. 24, 2013
(86) PCT No.: PCT/EP2013/001232

§ 371 Date: Oct. 27, 2014

(30) Foreign Application Priority Data
Apr. 27, 2012 (DE) 10 2012 008 400.5

(51) Int. Cl. B41F 17/24; D21H 25/06

(52) U.S. Cl. CPC B41F 17/24; D21H 25/06
USPC 101/217; 101/483; 428/219

(57) ABSTRACT

The present invention relates to a system for transferring images onto substrates (transfer printing) such as textile substrates, particularly T-shirts, cups, magnetic foils, mirrors or other smooth surfaces made of metal, leather, ceramics, wood, Plexiglas, cardboard or plastic. The invention also relates to a corresponding method for transferring images onto substrates, and to a siliconised and corona-treated paper.

The present invention relates to a system for transferring images onto substrates (transfer printing), such as textile substrates, in particular T-shirts, cups, magnetic foils, mirrors or other smooth surfaces made from metal, leather, ceramics, wood, plexiglas, cardboard or plastic. The invention also relates to a corresponding method for transferring images onto substrates.

During transfer printing, i.e. transferring images onto substrates such as textile substrates with the aid of so-called transfer paper, onto which the image that is to be transferred is applied in advance, under increased pressure and temperature conditions, an undesired background transfer often takes place, specifically to the transfer of parts of the coating of the transfer paper that are not part of the image. In order to prevent this, additional operating steps, such as contour cutting on the transfer paper and subsequent weeding, are necessary and/or the operation must be carried out at different temperatures during the preparation of the transfer paper and during the actual transfer process.

The present invention therefore provides a system and a method for the transfer of images onto substrates that overcome the aforementioned disadvantages.

The system according to the invention comprises a combination of substantially two components A and B.

Component A—hereinafter also denoted as a transfer sheet—possesses a layer structure and comprises a carrier and a toner layer that is arranged thereon on one side at least over part of the surface.

The carrier is, for example, foil, cardboard or paper, in particular a paper having a grammage of approximately 80-150, preferably approximately 90-100 g/m², such as a machine-finished paper that is suitable for (colour) photocopiers or (colour) laser printers.

At least one surface of the cited carrier or paper, i.e. at least the surface facing the toner, has a finish with anti-adhesive properties.

In the sense of the present invention, anti-adhesive properties are to be understood as a good level of toner adhesion on the surface in the hot state with simultaneously good separating or release properties, in particular of the toner in the cold state during the transfer process. This is caused by the carrier of component A being removed after the transfer of the image onto the substrate in the cold state, i.e. preferably in the room temperature range.

The anti-adhesive properties are particularly obtained by generating a hydrophobic and/or oleophobic surface by means of impregnation, coating, for example with polymers such as polyesters, polypropylenes or fluorocarbons, silicones or high-melting waxes, and/or by changing the surface structure, for example by changing, in particular reducing, the contact surface over specific roughness profiles.

Coatings with silicones or Quilon products (commercial products by the company Zaclon LLC) are preferred, wherein the carrier is optionally subjected to a surface treatment in the uncoated or coated state.

Quilon products are chromium (III) C₁₄-C₁₈ fatty acid complexes, e.g. CAS 65229-24-5, CAS 15659-56-0, CAS 15242-96-3.

The siliconisation takes place by means of, for example, thermal cross-linking or UV cross-linking into a polydimethylsiloxane structure. Corresponding methods and products that are, for example, also known as separating papers, are familiar to the person skilled in the art. A corresponding (silicon) coating preferably has a separation value of over 100 cN/20 mm, preferably approximately 100-200 cN/20 mm, in particular approximately 100-150 cN/20 mm.

Methods for changing the surface structure, e.g. by treating the surface by means of profile rollers, among other things, are also familiar to the person skilled in the art.

To improve the wettability of the surface and the adhesive force of the toner, the surface of the carrier can optionally be subjected to a further surface treatment to increase the surface tension, with a plasma or corona treatment in particular being performed according to the invention.

A toner layer is arranged on the correspondingly finished surface. Here, the toner is applied in the form of the desired image. In this instance, the toner layer is at least partially arranged on the surface, i.e. at least parts of the surface are covered with toner depending on the geometric shape of the image. Parts of the surface typically remain free from toner. Here, the application advantageously is performed by means of digital printing, laser printing, in particular by means of (colour) photocopying or (colour) laser printing, wherein commercially available toners are used. Such toners consist of the corresponding colour pigments in a plastic matrix, typically of polyester having a melting range of, for example, approximately 80-120° C. and, if necessary, auxiliary materials. Water-soluble or solvent-containing inks or sublimation inks, polymer inks, so-called flexo inks, screen printing inks, offset inks or suchlike are also considered as toners in the sense of the present invention.

The layer thickness of the toner layer is at technically typical values and is typically 5-50, preferably 5-20 g/m² (in grammage).

The carrier of component A is expediently designed in such a way that no background transfer onto the substrate takes place under the temperature and pressure conditions of the transfer of the image onto the substrate, i.e. at temperatures of approximately 100-150° C. minimum to approximately 200-250° C. maximum, for example approximately 100-250° C., in particular approximately 150° C. to approximately 200-250° C. maximum, in particular approximately 150-220° C., and also 180-220° C. and at a pressure of approximately 2-5 bars. In this case, background transfer means that parts of the potentially present coating of the carrier are transferred onto the substrate in the regions of the surface that are free from toner. In order to prevent this, high-melting coating materials, in particular silicones or Quilon products, are used, which have glass transition or softening temperatures in the region of preferably above approximately 250° C.

The use of correspondingly high-melting coating materials additionally enables the use of commercially available (laser) printers/photocopiers for applying the toner layer, since, in this respect, no contamination of the (laser) printer/photocopier is caused by the released parts of the coating.

In an advantageous embodiment, component A represents a siliconised paper having toner applied thereto in the form of the desired image.

The carrier of component A is particularly preferably a siliconised and corona-treated paper having a separation value of the silicones of over 100 cN/20 mm, preferably approximately 100-200 cN/20 mm, in particular approximately 100-150 cN/20 mm. The paper can potentially be subjected to a pre-treatment before the siliconisation, such as coating with, for example, polyvinyl alcohol or polyethylene.

The subject matter of the invention is therefore also a siliconised and corona-treated paper having a grammage of approximately 80-150 g/m² and a separation value of the silicones of approximately 100-200 cN/20 mm. The paper can, in particular, be used in systems and methods for transferring images onto substrates (transfer printing).

Component B—hereinafter also denoted as an opaque sheet—also possesses a layer structure and comprises a carrier, a polymer layer arranged thereon on one side and at least one further layer.

The carrier is, for example, foil, cardboard or paper, in particular a paper having a grammage of, for example, approximately 80-150, preferably approximately 90-100 g/m², such as a machine-finished paper that is suitable for (colour) photocopiers or (colour) laser printers.

At least one surface of the cited carrier or paper is finished with a polymer coating (also denoted below as an extrusion layer) made from polyolefins, polyolefin copolymers or polyurethanes having a layer thickness of approximately 30-60, preferably 25-50 g/m².

LDPE, optionally with maleic anhydride, EVA having a VA proportion of 7-28%, preferably 7-15%, ethylene acrylic acid copolymers or ethylene methyl acrylate copolymers having 5-12% acrylic acid, ethylene butyl acrylate copolymers having 5-20% acrylate are, for example, used as polyolefins, which preferably have a melting index according to ASTM-D-1238 (MFI) of 3.5-22, preferably 7-15 g/10 min at 2.16 kg/190° C.

The extrusion layer preferably contains wax. Paraffins or paraffin waxes or also mixtures of paraffin waxes with LDPE, for example, come into consideration as waxes. The waxes typically have melting points in the range of 60-100° C. In particular, a wax layer can additionally be arranged between the carrier surface and the extrusion layer, said wax layer typically having a layer thickness of, for example, 10-20 g/m².

In the process of transferring the image onto the substrate, the extrusion layer serves as an adhesive layer on the substrate. Accordingly, the extrusion layer advantageously has a glass transition or softening temperature that leads to a cohesive failure (cohesive fracture) in the extrusion layer when detaching the carrier of component B at a heat above the softening range, such that parts of the extrusion layer remain adhered on the carrier and thus a thin, flexible plastic layer is transferred onto the substrate.

The aforementioned detachment of the carrier of component B in heat takes place after the connection of component A (transfer sheet) and component B (opaque sheet), which takes place by pressing at approximately 2-5 bars in the temperature range of approximately 130-150° C. minimum to approximately 200-250° C. maximum, for example approximately 130-250° C., in particular approximately 150° C. to approximately 200-250° C. maximum, in particular approximately 150-220° C., in particular approximately 150-200° C., and also 180-220° C., typically for a minimum of approximately 15-20 seconds up to a maximum of approximately 60 seconds, in particular approximately 15-45 seconds, preferably 15-30 seconds. The detachment of the carrier of component B in heat typically takes place in the range of approximately 0-15 seconds after the pressing procedure.

The extrusion layer therefore advantageously has glass transition or softening temperatures in the range of approximately 60-80° C.

The further layer serves as a background layer for the toner layer of component A. Accordingly, the further layer is advantageously opaque and is hereinafter denoted as the opaque layer.

The opaque layer can be a metal coating which, for example, is applied by means of transfer metallizing or transfer metallisation with which the person skilled in the art is familiar; here, a thin (e.g. 0.05 gm²) metal layer (e.g. aluminium) is typically applied to a coated foil by means of a vacuum, said foil being laminated onto the carrier material. After a controlled drying process, the carrier film is removed and the metallisation remains on the carrier material. Advantageously, a primer or lacquer can be applied to the metal coating, said primer or lacquer optionally being corona treated in order to increase the level of toner adhesion.

To increase the colour gloss, the opaque layer is preferably a white layer.

The white layer contains 25-75% of a white pigment, for example titanium dioxide, chalk, barium sulphate, zinc sulphide, zinc sulphate or kaolin, preferably titanium dioxide, 75-25% of a plastic binding agent that can be a polyolefin, polyolefin copolymer or polyurethane, wherein reference is made to the above list of potential substances.

The white layer preferably additionally contains an inorganic crystalline substance, such as, in particular, silicic acid, but also calcium carbonate or bentonite. The proportion of the inorganic crystalline substance is typically approximately 10-30% relative to the dry quantity of the white layer.

It has been shown that the opaque layer is advantageously not very elastic and potentially has a certain level of brittleness.

The layer thickness of the opaque layer is approximately 2-15 g/m², preferably 4-12 g/m², in particular 2-8 g/m², especially 3-5 g/m².

The opaque layer advantageously has glass transition or softening temperatures in the range of approximately 160-180° C.

According to the invention, the opaque layer can also be a combination of a metallised coating and a white layer.

According to a preferred embodiment of the present invention, the component B additionally comprises a transparent layer that is arranged above the opaque layer. The transparent layer suppresses a mixing of the toner with the opaque layer and thus serves to further increase the colour gloss.

Here, the transparent layer consists of plastics that have a certain affinity for the toner colourants, i.e. they absorb these into their matrix and, on the other hand, do not discharge them again during washing. Plastics having softening temperatures of over 80° C., preferably over 100° C., which are not glutinous at typical washing and usage temperatures, are preferred. Optionally, additives such as silicic acid or cellulose esters or other known processing aids can be added. Polyester, polyurethanes, polyacrylates and other compounds, for example homo or copolymerisates of vinyl acetate, vinyl alcohol, vinyl chloride, methyl and/or ethylacrylic acid or methacrylic acid, maleic acid compounds and styrene, among others, are particularly suitable as the plastic.

Cellulose esters and cellulose ethers such as ethyl cellulose, benzyl cellulose, cellulose propionates or acetates or butyrates or also polyesters of terephthalic acid or polyamides such as nylon or Perlon are moreover suitable.

The layer thickness of the transparent layer is approximately 2-15 g/m², preferably 4-12 g/m², in particular 2-8 g/m², especially 3-5 g/m².

For the purpose of transferring an image onto a substrate, component A (transfer sheet) and component B (opaque sheet) of the system according to the invention are firstly connected to each other under the application of pressure and temperature. This expediently takes place by pressing at approximately 2-5 bars in the temperature range of approximately 130-150° C. minimum to approximately 200-250° C. maximum, for example approximately 130-250° C., in particular approximately 150° C. to approximately 200-250° C. maximum, in particular approximately 150-220° C., in particular approximately 150-200° C., typically for a minimum of approximately 15-20 seconds to a maximum of approximately 60 seconds, in particular approximately 15-45 seconds, preferably 15-30 seconds.

The anti-adhesive properties of component A thus guarantee that only a connection between the toner layer of component A and opaque layer of component B or the transparent layer potentially arranged above it takes place, but not between the toner-free regions of component A and the opaque layer of component B or the transparent layer potentially arranged above it.

Subsequently a detachment of the carrier of component B in heat is performed, typically in the range of approximately 0-15 seconds after the pressing procedure, with a cohesive failure (cohesive fracture) of the extrusion layer. This leads to the parts of the coating of component B, which cover the toner-free regions of component A, together with the carrier of component B, being detached or removed. As a result, a sandwich structure from component A is obtained, with only the layer structure of component B arranged above the toner layer: carrier A→toner layer→optional transparent layer→opaque layer→extrusion layer—optionally containing wax (after cohesive failure (cohesive fracture)). Depending on the composition of the extrusion layer, the optionally present wax layer (which can be arranged between the extrusion layer and carrier B) and the opaque layer, the cohesive failure (cohesive fracture) can also potentially take place in the optional wax layer or in a mixing region of the opaque layer and extrusion layer or the extrusion layer and optional wax layer. Accordingly, the structure of the sandwich structure obtained may vary.

In this state, the system according to the invention is ready to be used for the transfer of the image onto a substrate by the sandwich structure having the remaining extrusion layer being applied to the substrate and wherein the process takes place particularly advantageously under pressure and temperature conditions that are analogous to the pressure and temperature conditions of the connection of component A and component B. Therefore, this preferably takes place by pressing at approximately 2-5 bars in the temperature range of approximately 100-150° C. minimum to approximately 200-250° C. maximum, for example approximately 100-250° C., in particular approximately 150° C. to approximately 200-250° C. maximum, in particular approximately 150-220° C., in particular approximately 150-200° C., and also 180-220° C., typically for a minimum of approximately 15-20 seconds to a maximum of approximately 60 seconds, in particular approximately 15-45 seconds, preferably 15-30 seconds.

Then, the carrier of component A is detached or removed in the cold state. In the present instance, “cold state” means below the glass transition or softening temperatures of the layers, preferably in the room temperature range.

The system according to the invention preferably consists of a combination of components A and B.

The method according to the invention for transferring images onto substrates comprises:
providing a system according to the invention, comprising components A and B;
connecting component A and component B under the application of pressure and temperature by pressing at approximately 2-5 bars in the temperature range of approximately 130-150° C. minimum to approximately 200-250° C. maximum, for example approximately 130-250° C., in particular approximately 150° C. to approximately 200-250° C. maximum, in particular approximately 150-220° C., in particular approximately 150-200° C., and also 180-220° C., typically for a minimum of approximately 15-20 seconds to a maximum of approximately 60 seconds, in particular approximately 15-45 seconds, preferably 15-30 seconds;
detaching the carrier of component B in heat, expediently above the softening range of the extrusion layer of component B, typically in the range of approximately 0-15 seconds after the pressing procedure, to obtain a sandwich structure;
applying the sandwich structure with the extrusion layer of component B onto the substrate, wherein, depending on the composition of the extrusion layer, the optional wax layer and the opaque layer of component B, a cohesive failure (cohesive fracture) potentially also takes place in the optional wax layer or in a mixing region of the opaque layer and extrusion layer or the extrusion layer and optional wax layer. Accordingly, the structure of the sandwich structure obtained and, in this respect, the layer that is to be applied to the substrate, may vary;
subsequent pressing at approximately 2-5 bars in the temperature range of approximately 100-150° C. minimum to approximately 200-250° C. maximum, for example approximately 100-250° C., in particular approximately 150° C. to approximately 200-250° C. maximum, in particular approximately 150-220° C., in particular approximately 150-200° C., and also 180-220° C., typically for a minimum of approximately 15-20 seconds to a maximum of approximately 60 seconds, in particular approximately 15-45 seconds, preferably 15-30 seconds, wherein the image is transferred onto the substrate; and
detaching the carrier of component A at a temperature below the glass transition or softening temperatures of the layers, preferably in the room temperature range.

The method according to the invention can be carried out with typical devices—so-called transfer presses. In a particularly advantageous manner, the step of connecting components A and B as well as transferring the image onto the substrate can be carried out under the same pressure and temperature conditions, which causes the procedure to progress particularly simply and quickly, since no additional cooling and/or heating phases are necessary. Accordingly, no changes to the settings of the transfer press used are advantageously to be undertaken.

Insofar as nothing different is specified or necessarily arises differently from context, percentage values relate to the weight, and in case of doubt to the total weight of the mixture.

The invention also relates to all combinations of preferred embodiments, insofar as these are not mutually exclusive. The specifications “approximately” or “approx.” in connection with a numerical value mean that values that are at least 10% higher or lower or values that are 5% higher or lower, and in any case values that are 1% higher or lower, are included.

1. System for transferring images onto substrate, comprising a combination of two components A and B, wherein
component A comprises a carrier and a toner layer that is arranged thereon on one side at least over part of the surface and at least the surface of the carrier that is facing the toner has a finish with anti-adhesive properties,
component B comprises a carrier, a polymer layer arranged thereon on one side and at least one further layer;
wherein at least one surface of the carrier is finished with a polymer coating (extrusion layer) made from polyolefins, polyolefin copolymers or polyurethanes having a layer thickness of approximately 30-60 g/m², and
the further layer is an opaque layer, wherein the layer thickness of the further layer is approximately 2-15 g/m².

2. System according to claim 1, wherein the finish of the carrier of component A is a coating with silicones or Quilon products, which is optionally additionally corona-treated.

3. System according to claim 1, wherein the carrier of component A is a siliconised and corona-treated paper having a separation value of the silicones of over 100 cN/20 mm, preferably approximately 100-200 cN/20 mm, in particular approximately 100-150 cN/20 mm.

4. System according to claim 1, wherein the opaque layer is a metal coating and/or a white layer containing 25-75% of a white pigment such as titanium dioxide, chalk, barium sulphate, zinc sulphide, zinc sulphate or kaolin, preferably titanium dioxide, and 75-25% of a plastic binding agent being a polyolefin, polyolefin copolymer or polyurethane, wherein, advantageously, an inorganic crystalline substance such as, in particular, silicic acid, but also calcium carbonate or bentonite, is additionally contained.

5. System according to claim 1, wherein component B additionally comprises a transparent layer that is arranged above the opaque layer.

6. System according to claim 1, wherein components A and B are designed to be able to be connected to each other under application of pressure and temperature.

7. Siliconised and corona-treated paper having a grammage of approximately 80-150 g/m² and a separation value of the silicones of approximately 100-200 cN/20 mm.

8. Method for transferring images into substrates, comprising:
providing a system according to claim 1, comprising components A and B,
connecting component A and component B under application of pressure and temperature by pressing at approximately 2-5 bars in the temperature range of approximately 130-250° C., typically for approximately 15-60 seconds,
detaching the carrier of component B in heat typically in the range of 0-15 seconds after the pressing procedure, to obtain a sandwich structure,
applying the sandwich structure with the uppermost layer remaining after the detachment of the carrier of component B, preferably the extrusion layer of component B, to the substrate,
subsequent pressing at approximately 2-5 bars in the temperature range of approximately 100 to 250° C., typically for approximately 15-60 seconds, and
detaching the carrier of component A at a temperature below the glass transition or softening temperatures of the layers, preferably in the room temperature range.

9. Method according to claim 8, wherein the connection of component A and component B and/or the pressing after the application of the sandwich structure is(are) performed at approximately 150-250° C., in particular at 150-220° C. for approximately 15-45 seconds, preferably 15-30 seconds.

10. Method according to claim 8, wherein the detachment of the carrier of component B in heat is performed above the softening range of the extrusion layer of component B.

11. Method according to claim 8, wherein the step of connecting component A and component B and the pressing following the application of the sandwich structure are performed under the same temperature conditions, preferably at approximately 180-220° C.
